(19) United States
(12) Patent Application Publication
(10) Pub. No.: US 2005/0033747 A1
(43) Pub. Date: Feb. 10, 2005

(54) Apparatus and method for the server-sided linking of information

(76) Inventor: Erland Wittkotter, Hayward, CA (US)

Correspondence Address: Dr. Erland wittkotter, 25200 Carlos Bee Blvd., Hayward, CA, 94542, US

(21) Appl. No.: 10/852,875

(22) Filed: May 25, 2004

(30) Foreign Application Priority Data
May 25, 2003 (DE) 103 23 992.8

(51) Int. Cl. G06F 7/00

(52) U.S. Cl. 707/10

(57) ABSTRACT

The invention pertains to an apparatus for the client-sided receiving, transmitting, delivering, representing, outputting and displaying of server-sided stored data by means of unambiguous or unique content signatures, which together with additional data, are stored on the server-side. Server-sided additional data are called via this content signature on the server-side by a client-sided program. Additional data are displayed on the client-side and can be used as hyperlinks for further searches or linking. Further additional data can be inserted on the client-side by creators related to content signatures, which are transmitted to the server and stored on the server-side. Via the assignment of predetermined category names, server-sided additional assignments can be defined for category terms and upon client requests, after which it is sent to the client.

### CROSS-REFERENCE TO RELATED APPLICATIONS

Not Applicable

### STATEMENT REGARDING FEDERALLY SPONSORED RESEARCH OF DEVELOPMENT

Not Applicable

### REFERENCE TO A “MICROFICHE APPENDIX”

Not Applicable

### BACKGROUND OF THE INVENTION

The present invention pertains to an apparatus for the client-sided creating, receiving, transmitting, delivering, representing, outputting and displaying of server-sided stored data, as set forth in the classifying portion of patent claim 1.

### DESCRIPTION OF THE RELATED ART

Because of the large and almost unmanageable amount of pictures, videos and multimedia content contained within the Internet, which can be received and/or called from many homepages and information portals, and because of the relatively low number and low quality of additional text-based information, which might be inaccurate as well, and which might be directly assigned by means of contained metadata to binary content, the direct finding and/or location of these images and video-data via text-based search engines is a difficult, incomplete and very unreliable task.

Currently, text-based information or data for the description of content are contained in the content file names or as metadata within pictures, or within the page as alternative text, or as content description such as a caption. Furthermore, only the publisher or content editor can define or determine which information should be attached to the digital content and thereby determine if this content could be found via search engine through means of terms or could be used for linking to other information.

In the following text, the term “content” is interpreted as data, files or data-streams, in particular the actual representation of what the data in the suitable or adapted output medium stands for. The content can be the same, whether or not it is represented in different data records or data formats, where its binary output is represented differently.

In that respect, an important problem within current state-of-the-art technology is that there are already several billion pictures, images or multimedia binary files are available within the Internet, and that an automatic evaluation and assignment dependant upon text-based terms or information cannot be done reliably enough within existing technologies. Furthermore, the peril exists that in a search for multimedia content, too many wrong, erroneous, incorrect or inaccurate results are displayed.

A further problem is that a user can see an image, and based on the content of this image, he would like to have additional information. Due to the high qualitative information density of the image content, nobody, in general, can know in advance what users or viewers of a specific image might be interested in. Therefore, all previous, editorial assignment or associations to descriptive metadata are inevitably insufficient.

With respect to state-of-the-art technology, there is no reliable or flexible opportunity to assign in previously published content further references or hyperlinks to other web servers, providing, for example, further distributed textual or multimedia content. Thereby, a user of said multimedia content has no opportunity to obtain further details by means of additional data.

Thus, for instance, image-maps offer users the opportunity to provide server-sided information by means of mouse-activated or mouse-sensitive zone of a corresponding image. Thereby, client-sided extracted data are sent to the server and the server sends the corresponding response data to this request back to the client. In another embodiment of image-maps, different image zones are already connected to data and hyperlinks, which are already available on the client-side. The initial effort to create these image maps is very large and the supplemental additional data remains basically incomplete, because within this process it cannot been known in advance what the viewer of a picture is interested in. Furthermore, during the creation or production of the assigned information, it has to be considered that the server address and the parameters remain unchanged for the future, in order to prevent the occurrence of a corresponding error message. A further disadvantage of this technology exists therein, that additional content such as metadata can only be connected or integrated by the publisher of the picture and not by an independent third party.

CGI (Common Gateway Interface), Java™ or hyperlink call, which are known in state-of-the-art technology, and which can be connected to pictures, can transmit client-sided extracted data to the server. Disadvantageous is that additional information for images, which are distributed from the original publication context by copying, extracting or the like, and which are linked to CGI, Java™, alternative texts, captions or additionally connected hyperlinks could be lost. In addition, for client-sided storage of the server addresses by users, these data have to be maintained with additional effort in order to avoid error messages. The subsequent effort to validate the correctness of hyperlinks or to deal with client-sided error messages is considerable and its avoidance is desirable. Additionally, further hyperlinks or additional data, which are available server-side, can only be generated by the original publisher or website programmer, but not by an independent third party later on.

Different content formats offer the opportunity to include additional data as metadata in a corresponding content file or within the content file. If textual terms are inserted into the content by the publisher prior to the publication or prior to analysis by a search engine, then the opportunity exists to find these textual terms via search engines. If the address of this content file has been changed, then the problem will result that the file cannot be found anymore and a later assignment to a new address can only be reestablished after the next analysis of the web page by the search engine.

Additionally, the subsequent insertion of metadata or additional data in existing content files is very costly, and sometimes almost impossible to achieve especially if the file is no longer in the direct control of the reviser or editor. Because the content cannot be updated later on, this limitation would be disadvantageous for utilization in distribution via Internet.

A further technology exists therein, such that notes or contributions to discussions can be subsequently attached to web content. This technical solution can be installed as a web browser plug-in and it enables the user to create textual contributions as additional content alongside displayed content. These attachments are then provided to other users. If the address of the commented content is changed, the link between the content and the comment would be deleted and further usage of the created comment is no longer possible. On the other side, the concrete task of this technology requires the creation of a direct connection or relationship between a web server address and a notice or a contribution to the discussion.

A general disadvantage of existing technologies is related to the fact that the content owner or publisher have no contact anymore with the user or viewer of the content after publication occurs, and that a contact or connection cannot be established from the user or viewer side to the content owner, even if the user or viewer wishes to do so. The close link between content and the actual content owner, which is usually characterized by possession, would be lost after publication, and thereby the opportunity that is associated with this possession to establish a link with the user or viewer would also be lost. The establishing of this link, which contains the opportunity for establishing communication cannot be easily be realized within the known state-of-the-art technology, as it is insufficient and unreliable.

The utilization of unambiguous or unique content signatures for server-sided extraction of path data to the address of corresponding reconstruction keys, as disclosed in the invention DE19950267.6-31, is used for server-sided controllable or manageable release of content. Thereby the technology is designed in a manner that additional server-sided stored data are not displayed on the client-side. Additionally the technology is not designed in a manner that further additional data could subsequently be assigned to the content. Furthermore, the additional data contains, according to the present invention, data, which are entirely and mutually independent from corresponding digital content for which the digital signature has been created, and which provide value-added information. On the other hand, the additional data that are used in the present invention are not necessary in order to decode or reconstruct the digital content in a meaningful manner.

The purpose of the present invention is to create an apparatus for client-sided creating, receiving, transmitting, delivering, representing, outputting and displaying of server-sided stored data as set forth in the classifying portion of claim 1, in which the client-side displayed data by means of a unique, content-data-dependant, content-signature on the server-side is associated with additional data, and that this content-dependent additional data is creating, receiving, transmitting, delivering, representing, outputting and displaying on the client-side.

The objective is achieved by the apparatus with the features of claim 1. Advantageous development of the invention is described in the related, dependent claims.

In a manner according to the invention, the client-side is creating, receiving, transmitting, delivering, representing, outputting and displaying data processed on an electronic data processing unit that is typically a PC, which is connected with a server unit by means of an electronic network. The data processing equipment provides a document-visualization/output/representation unit, in which the electronic document is displayed.

Electronic documents, such as files or streams, including text, pictures, images, music, audio, video, animations or software-based applications are called in a known manner from the document server unit, application server, file-server, database-server or web-server by a client computer. The electronic document that is displayed on the client computer can also be stored locally. The transmitting of the data is done via electronic network through the existing standardized communications protocols such as TCP-IP, UDP, HTTP, FTP or the like. The electronic document is represented, displayed or played in the document visualization, output or representation or in other digital visual, video- or audio- visualization/output/representation unit, as well as in an appropriate program execution platform. The document-visualization/output/representation unit is in a preferred embodiment of the invention, a web browser, an audio-visual media-player or a content editor.

The function unit, which is assigned to the document-visualization/output/representation unit, is able to access the electronic document or parts of this document. It is also suitable to transfer or transmit data over the network. This function unit can be contained in the document-visualization/output/representation unit or it can be enclosed within a Plug-In, or it can be a component, which appears in a web browser as a toolbar or as an explorer bar, or as a program or context menu item. Additionally, this function unit can be downloaded from a server via the electronic data communication network and can be executed within a client-sided program execution platform.

According to the invention, the function unit can create, by means of a content signature unit, a plurality of unambiguous and unique digital signature data of the content, meaning signatures of content data and document segments, or of file-content or of the plurality of files or of digital data, which are creating the images, video, music or multimedia animations, which are contained in the displayed electronic document. The digital signature can be a hash code, which is created on the electronic content-file directly or after a filter or a data converter has been applied. The digital signature, which can be dependent or independent of the data format, can make use of distribution of gray or color values within an image in order to distinguish data or files unambiguously or uniquely. Additionally, digital signature data can be used to recognize similarities automatically, or it can be used to calculate distances via digital signature data between images and finding similar images via database access and via an efficient ordering scheme. In these digital signatures, file format values can be contained as well, such as image sizes or compression method, in order to achieve a fast and unambiguous, or unique distinction, or difference between different data or files.

Preferably, the digital signature can be created in a manner that the corresponding signature data of content data, which have been stored after conversion in diverse or different output formats, and which have been derived from a common source, shows a very high conformity via signature data, such that even content files with diverse or different based can automatically and mutually be identified via signature data.

The electronic signature data is used in the server-sided signature-data-to-additional-data relationship unit to select and/or to determine and/or to calculate additional data, which are stored and assigned via relationship therein. The additional data, which are associated with a particular digital signature, are sent from the server to the function unit where they are displayed in or via the document-visualization/output/representation unit.

Content for which content signature data have been created are invariant with respect to additional data. The additional data does not change the content that correspond to the signature data. The additional data are preferably adapted for display in the client-sided visualization/output/representation unit or as hyperlinks to enable and to provide links with additional resources.

The additional data can preferably be displayed via the document-visualization/output/representation unit in an independent window, or it can be processed by the function unit as a data record. Thereby, server-sided additional data are preferably data in which options are contained that can be activated by the user. These options, which can be activated by the user, consist of a plurality of displayable textual data and/or image data and/or multimedia data and hyperlinks. These hyperlinks can be activated within a further embodiment of the invention via the user manually, whereby these client-sided activation data can be transferred as a data record or as a plurality of data records to the server unit, whereby this server unit or other predetermined plurality of server units can subsequently transfer further additional data to the client. The data, which are transferred by the client-sided function unit to the server, contain in a further-preferred embodiment, content signature data, which are stored on the server together with the client-sided selected data, such as category or topic names, in the signature-data-to-additional-data relationship unit.

The server-sided additional data related to the digital content, which is identified by means of digital signature, consists of data, which are stored in correlation or context to the previous requests for additional data that have been stored and/or calculated via coupling values with and/or between available server-side, standardized category- or topic-terms and/or adjacent or assembled content-specific or via content-unspecific data by standard templates.

Additionally, client-sided, webpage-specific context data, which is in correlation or context with the file or data to which the content signature has been associated, and which can be used to create or extract via the client-sided function unit from the electronic document, corresponding metadata, and/or calling address of the electronic document, can be transferred to the server unit.

In a further embodiment of the present invention, context data are assigned to a plurality of predetermined category names, topics or subject names within the signature-data-to-additional-data relationship unit, such that on the server-side via a relationship assignment unit, the context data can be linked to a plurality of category-oriented or related and predetermined data, as well as on a plurality of links to document server and/or on scripts, which are dynamically executable on the client-side.

The relationship between context data and category-related data can be represented by coupling values, which are determined by a numerical value. This value can be regarded as constant or it can be calculated dynamically. It can also be supplied with an order relationship scheme that can establish a sequential order. Furthermore, digital signatures can also be associated via coupling values with different or diverse category names.

In comparison with a concrete document server address, the category names are static or invariant and they can be used to describe the content or a textual aspect of the file that is described by a reliable, understandable and comprehensible signature.

In a further concrete embodiment, the category name can show a hierarchical and/or network-type name relationship. The category names are terms including the generic or the specific, which are associated in textual- or meaning-related, or relational correlation, or in context with the context data. The category names can comprise predetermined attribute values or characteristic values. The category names have a relationship or association to the meaning with the content, such that the content can be described by means of corresponding category-name descriptions and corresponding metadata.

Category names are preferably taken as predetermined values from a common catalog unit. The catalog unit can be available on the client-side as well, or by means of network access, such that it will be taken from a server-sided catalog unit.

Because the category names that are contained within the catalog unit are invariant terms, the corresponding equivalent translations in other languages can be assigned to these category names and thereby, there can be created a multilingual conceptual system of references, in which for each potential image at least one term of the selected language can be assigned. Additionally, creators or editors can extend the catalog of subcategory names and/or of further term relationships between category names within the framework of Open Directory Initiatives.

Further term or topic relations can be extracted via the continuous usage of terms or topic catalog (taxonomy) within accumulated user-sided activated sequences of pair of terms and link relations between found pairs of terms, which can then be adapted via changing the coupling values between these terms.

According to the invention, the hyperlinks can contain supplementary data that can be used to identify a creator or a designer of the relationships between the digital signature data and the category name, such that in a utilization of the hyperlinks, which is associated and linked with the category name, the actual or original creator of these relationships can also be materially compensated if necessary, or all data created by this creator can generally be verified, or the data can be deleted if necessary, in particular if within the data creation or data generation an improper, unsuitable, noxious or malicious behavior is discovered. Thereby, the utilization or activation of hyperlinks, which are delivered via the server and contained in the additional data and therein-contained hyperlinks, can be registered on the server-side in a hyperlink-utilization-registration unit and the utilization or activation of a hyperlink that has been transferred via the server unit to the user, and can thereby be recorded or registered easily.

The hyperlink data that is displayed on the client computer can be stored in the relationship-creation-unit-for-additional-data on the server-side and can subsequently be changed independently of the signature-relationships and independently of the corresponding content. Additionally, the predetermined category names can refer to a list, catalogue or inventory of server addresses with the corresponding parameters and thereby can refer or link to further corresponding document-servers.

In a concrete embodiment, the additional data are visual, acoustic, audio, sound or multimedia data, or they are descriptive data or predetermined utilization operations, such as hyperlinks, which refer to a predetermined server-sided document server unit or product database, which can be requested or activated by a user. After activation of hyperlinks, the corresponding data records are received by the requested document server, after which the document-server sends its requested data records for subsequent display on the client-side.

Within a further embodiment, the utilization operation can be predetermined dynamic script operations, such that the client-sided data can be displayed in an animated manner and/or displayed with further server-sided received data. From the server-sided database or server, further additional data, which are related to the content, can be requested by means of the digital content signature data or by means of additional data which are assigned to the signature data, such that these additional data can subsequently be displayed or stored on the client side and/or can be processed by the client-sided data processing equipment.

In a further embodiment of the invention, the additional data provided by the server can be used within the client-sided document-visualization/output/representation unit that ensures the corresponding content will not be output, such that within the framework of a parental control system, questionable content can be suppressed or skipped via server-sided additional data on the client-side.

In a further embodiment of the invention, the output, display or playback of the content, which can be perceived as disturbing, can automatically be recognized, and its output can be suppressed or excluded via additional data.

In a further concrete embodiment of the invention, additional data that are delivered by the server can be transferred to the client-sided data-storage appliance or unit, on which the data can be stored and managed, such that without further server requests, the client-sided stored additional data can be displayed, requested, indexed, searched and used offline.

In a further concrete embodiment of the invention, visual tags for a part or within parts of the electronic document such as for picture or image files, or for paragraphs can be attached or inserted, such that it can be made recognizable for the user on the client-side, on locally-displayed content for which server-sided additional data are available or can be generated.

In a further preferred embodiment of the present invention, the function unit provides a creation unit for creating additional data or a category-name-assignment unit, in which an editor or creator can manually assign additional data to selected document segments, or in which the function unit can generate additional data to files within or inside the displayed electronic document and these data can subsequently be transferred together with the digital signature to the server unit and can be stored in the signature-data-to-additional-data relationship unit. Thereby, the function unit can receive data corresponding to a category that is determined by an editor or reviser, from a server-sided signature-data-to-additional-data relationship unit, in which data are contained or assigned by previous viewer- or client-sided assignment of content or content signature data to category names, where its correctness has yet to be validated. The available data can then be validated or refined by this editor or reviser.

In a further embodiment of the invention, improper, unsuitable or incorrect assignments of category names to content via destructive creators or revisers can later on be removed by means of server-sided characteristics or means of creator identification. In a preferred manner, the server unit can store the additional data only from registered and authenticated creators.

Additional data can be person's or people's name(s), personal description(s), characterization(s) of person(s), or the like, or product name(s), product description(s), product tag(s), product parameter(s), commercial symbol(s), trademark(s) or the like, or toponym(s), place name(s), landscape(s) or territory name(s), street name(s) or the like, or building or structure name(s), description(s) of a building or structure, sign(s), symbol(s) or attribute(s) of a building or structure or the like, or means for transportation or conveyance, description(s) of transportation or conveyance, or name(s) of (a) work(s) of art, description(s) of (a) work(s) of art the like, or animal name(s), animal species, class or classes of animals, animal description(s), characterization(s) of animals or the like, or plant name(s), name(s) of plant species, plant description(s), characterization(s) of plant(s) or the like, or event name(s), event description(s), food name(s), recipe(s), recipe name(s) or recipe description(s) or the like, or description(s) of situation(s), object description(s) for technical object(s), production or manufacturing facilities, machine(s), engine(s), robot(s), or technical description(s) or the like, or chemical, mathematical or physical formulas, astronomical picture(s) or image(s), images from scientific activities or the like, or content name(s), content type data, content description(s), content metadata or the like.

Additionally, additional data can be name(s) or description(s) of light ratio(s), amount of light, special effect(s), surface(s) or physical description data, size, extent, description or descriptive parameter(s) or name(s) and description(s) for movement(s) of person(s) or object(s) or group(s) or the like, role(s) or function(s) of person(s) or group(s) of person(s), characteristic(s) or attribute(s) of (an) object(s) or characteristic(s) or attribute(s) of person(s), or description(s) of simulation(s), description(s) of method(s) or procedure(s), description(s) of utilization(s) or use(s), hint(s) or advice on danger(s) or hazard(s) or the like, or data referring to the color spectrum, or data on the correlation or context of scene(s), such as scene sequence(s), scene hierarchy or hierarchies, or scene description(s) or the like, or visual, sound or multimedia contextual descriptions or the like, chronological or causal sequentiality or succession or description(s) of the background(s) or of geographic or relative positioning or of author name(s), manufacturer name(s), editor name(s), supporter name(s) or sponsor name(s) or legal partnership(s) or proprietorship(s) or digital rights management description(s) or symbol name(s) or symbol description(s) or trademark-sign(s) or symbol(s).

In a concrete embodiment of the invention, the function unit can be designed, displayed or characterized as software or application components within a toolbar or as a program- or context-menu-item in an Internet-capable document-visualization/output/representation unit, whereby this output unit can be a web browser or a media player in which the operations for the data selection, data extraction, data-management, data-representation, presentation and data assignment can occur in a program-execution unit or platform of the document-visualization/output/representation unit. The language for programming of operations in this program-execution unit or platform can be JavaScript, Java™ or Visual Basic.

The additional data such as category names and/or corresponding attributes and/or metadata, which are stored in the server-sided unit related to the content, can be indexed and searched as textual data together with the corresponding content name and/or content address in a text-oriented search engine, in order to search, find and/or make an automatic categorization of multimedia content data via text-related or oriented key terms or attributes.

In a further embodiment of the invention, for similar but Internet-distributed content related to or corresponding with metadata or additional data that correspond to these files can contain additional and diverse or different information, whereby servers can be used to exchange these data between these files, or a data synchronization can be performed with respect to metadata or additional data.

In a further embodiment of the invention, movies or videos can be segmented into scenes, whereby a scene can consist of a coherent or connected set of single images and the scene can be supplied with a plurality of additional data.

### BRIEF DESCRIPTION OF THE SEVERAL VIEWS OF THE DRAWING(S)

Further advantages, features and details of the invention will be apparent from the following descriptions of preferred embodiments and with references to the following drawings:

FIG. 1 a schematic image for the search and assignment of server-sided additional data

FIG. 2 a schematic block diagram for the creation of additional data

FIG. 3 a schematic image of the client-sided utilization interface for the creation and assignment of additional data

FIG. 4 a schematic image of the client-sided utilization interface for requesting additional data from the server-side

### DETAILED DESCRIPTION OF THE INVENTION

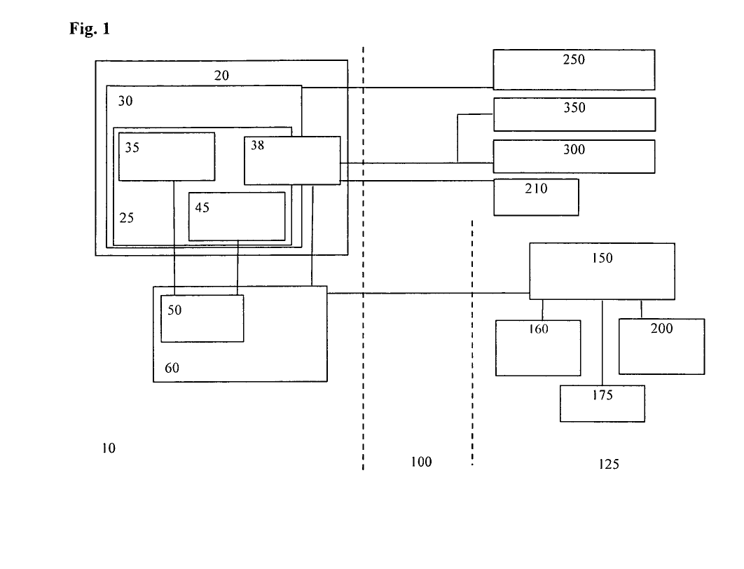

FIG. 1 describes a schematic image for the search, reception, transfer/transmission and display of server-sided, stored and/or managed additional data on a network-capable data-processing unit (10) that is connected with the server equipment (150) by means of a data transmission network (100).

Electronic documents (25) are displayed by means or device for the representation, presentation or display of a document or a document-visualization/output/representation unit (30), such that its outcome or result or output values are displayed or shown in a means or device for the visual or acoustic, audio or sound output of data or in an output unit (20). The displayed electronic documents can be stored locally or they can be transferred and received via the network (100) by means of requesting, storing, transmitting or transferring of electronic document(s), which is also referred to as document server unit (250).

The electronic document (25) consist of data, which is made up of document-segments (35) and/ or document files (45), such as independent animation files, image files or music/audio/video files or data streams.

The electronic document (25) is accessible via means or device for the access of data in the electronic document that is contained in the document-visualization/output/representation unit (30) and which is also referred to as a function unit (60). The function unit (60) can be formed in a manner such that it can also access the document outside of the document-visualization/output/representation unit (30), such as via its data representation. The function unit (60) is a software application, in which a means or device for the calculation or determining of the digital signature is contained, or which is also referred to as a signature unit (50) that can create an unambiguous or unique digital signature of an amount of data or file within the electronic document.

The signature unit is creating by means of a hash procedure or hash method such as an SHA or the like, a digital signature, as it is known in state-of-the-art technology, of paragraphs, text passages or files within the document. These signature data are sent via the function unit (60) to the server unit (150) by means of the network (100). The signature data are then used in the signature-data-to-additional-data relationship unit (200) to identify, select and transfer and/or transmit additional data, which are related and assigned to the content signature from the additional data relationship unit, to the client-sided function unit (60) via the network (100). The data, which are received in the software application (60), can be displayed in the document-visualization/output/representation unit (30) or via the output unit (20).

The document segments (35) or the images (45) can contain additional visual tags, which are attached to content or which are only displayed when the corresponding signature data have been found within the signature-data-to-additional-data relationship unit (200).

In an embodiment of the present invention, behind the visual tags further data such as content description, metadata or the like are contained, which for instance can be called or activated via mouse-over event/effect. Additionally, within the additional data hyperlink data can be contained, which are formed or designed in a manner, such that they are transferring or receiving activation data to an arbitrary document server and/or receiving additional data from a server-sided database (210) or receiving document data transferred from a server-sided document server unit (300). The activation of a hyperlink within the additional data can activate, initiate and/or perform a call of an event or an operation via a server-sided means for the storing of the utilization of hyperlinks (350) that is activated on the client-side, so that the corresponding server-sided service can also be referred to as a hyperlink utilization server (350). A technical realization of these utilization servers (350) can be done in a manner that an HTTP request would first address the server (350) and subsequently be redirected by means of a server-redirect to the actual or original target of the hyperlinks, i.e., the document server (300). The received additional data are then displayed on the visual interface (38) or by the document output unit (20). In an alternative manner, the data about the utilization of hyperlinks on the client-side can be buffered or cached and thereby can be transferred to the server later asynchronously.

In a further embodiment, the signature data can be linked with category names in the signature-data-to-additional-data relationship unit (200). The category names result, are taken or are derived from a means or device for storing or outputting of catalog data or via catalog data unit (175). For each category name there is a plurality of further data in the catalog-server-assignment/classification/correlation unit (160), such that at least one or a plurality of hyperlinks on document server (300) are managed via a table and are assigned to at least one or a plurality of catalog terms. The data that are contained in the assignment, classification or correlation unit can also contain a tag for the provider of the category names or the hyperlinks, or the server unit (160) can contain a management unit in which only entitled or eligible providers of category names or of hyperlinks, or of structured or unstructured additional data, such as editors, operators or entitled or eligible identified users, can insert values. These values can be verified and approved in a further embodiment of the server unit (160) by master editors or moderators, before they are provided to other users of the assignment, classification or correlation unit (160).

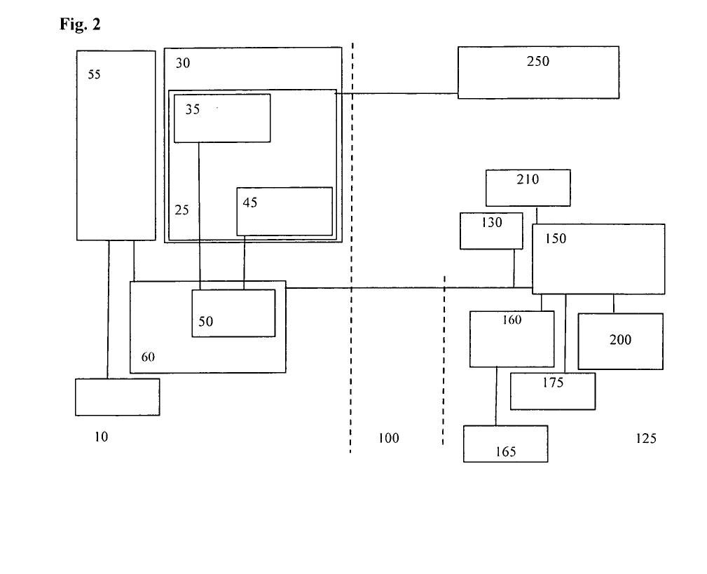

FIG. 2 describes in a block diagram a realization example for the creation of additional data. Beside the references that are already described in FIG. 1, there exists in the function unit (60) a component for the creation and assignment of additional data related to content, which is selected in and/or by the document-visualization/output/representation unit. The means or device for the creation and assignment of additional data, which is also referred to as the creation-unit-for-additional-data (55), enables the assignment of category data to digital signature data, which are extracted and created from the selected document segment or from pictures or images taken from the electronic document (25).

The category names are taken out of a database or storage unit such as the local catalog data unit (175′) or the server-sided catalog data unit (175).

The transmitting/transmission/transferring of client-side-created data to the server unit can be made dependent upon the identification and/or authentication by the identification and authentication unit (130), such that operations on the client- or server-sided means or device by the creator, generator or producer of additional data can be identified and authenticated. Characteristics or attributes that identify the creator of the additional data can as part of the data record be inserted and stored in the signature-data-to-additional-data relationship unit. With these characteristics or attributes not only a single individual data record entry can be deleted, but also all data record entries of a potentially destructive creator can subsequently be verified and/or deleted. The creator can also generate structured data for the database (210) and transfer it to the server unit (150).

In a further embodiment, in the web server with corresponding database there can occur an assignment on web server addresses and/or data input templates (165). In the relationship unit (165) a relationship between a category name and a plurality of document server addresses and/or a plurality of data request forms are managed, which are transferred from the web server unit (160) to the client unit of the user or editor or reviser, and on that unit they are used for the assignment of additional data.

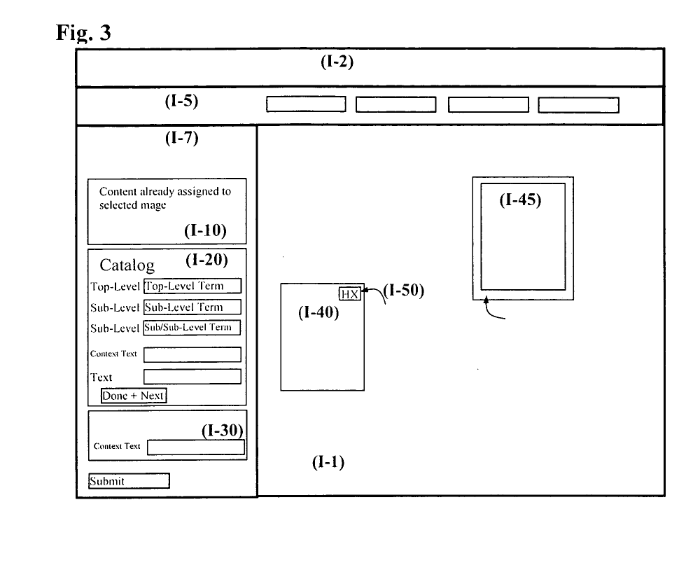

According to the present invention, FIG. 3 describes the interface in a web browser for the assignment of additional data. The electronic document (25) will be displayed by and within the interface (I-1). The picture (45) is referred to in FIG. 3 with (I-40). The picture that is selected by the user, editor or reviser is marked with (I-45). The selections occur with operations that are determined by the operating system and input means, for instance via computer mouse (event) . The web browser possesses a navigation bar (I-2) and also the opportunity to insert an additional toolbar (I-5) into the web browser. The creation unit for additional data (I-7) can be made available as an explorer bar to the left side of the window (I-1) according to a preferred manner. Already-attached additional data can be displayed in the area (I-10). New additional data are searched, selected and determined in the interface segment (I-20) by the editors or revisers via the catalog data unit and via the hierarchically arranged top- sub-level category name schemes. Further, additional text related data can be attached in the interface (I-20) by a creator, and by means of “Done”, “Next” or “Enter” buttons, further additional data can be stored by the creator, editor or reviser after confirmation.

In an additional interface (I-30), an input mask or form that is adapted to the category name can be displayed according to the chosen or selected category name. Thereby an adapted, appropriate or suitable interface can be used for the structured input of attribute values or additional data accordingly. Each of these input masks or forms would be capable such that the data are already structured before they are inserted and stored in a database and accordingly, this can be used in user-sided requests and assignments for the improvement of the resulting output.

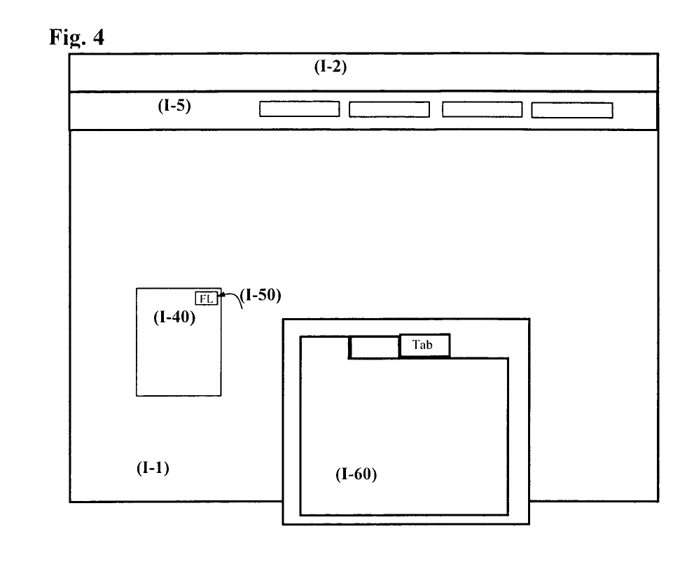

FIG. 4 describes in the schematic picture the client-sided utilization interface, in which for a chosen selected picture, corresponding additional data that are requested from the server, are displayed by and for a user and are used for further navigation. Beside the already-described references in FIG. 3, the figure contains a further interface (I-60), in which further additional data to the chosen picture or image can be displayed. With the opening of the interface (I-60), category names that are stored on the server-side can be displayed, from which the user can more accurately select which refinement of the terms the user wishes, or whether he refers to the corresponding hyperlinks from the category names, which are linked to other Internet resources, and/or whether he displays textual additional data. The refinement of the category names is used as a technically exploitable hint by the server or as a data record that indicates what is seen in the image- or video-content and for what in detail other users or viewers may also show interest. These hints are processed by the server-sided data processing unit and prepared as data that can be displayed by the interface (I-60) of other users or viewers.

If no server-sided data are available, then the function unit, which is collaborating with the interface (I-60), can extract context data from the electronic document, in which the image or the file is contained, and from which the interface has been opened. The context data can be extracted from text passages within the electronic document or from the metadata of the electronic document, from alternative texts that belong to the content or from corresponding or assigned files, and consequently textual terms are displayed within the interface (I-60). The user or viewer can either activate one of these displayed terms or he can manually insert a new term and to send it to the server, whereby implicit correlation or context-similarity between the picture, image and the term is assumed. Upon the returning of potential term refinements, the user can further specify his interest and thereby receive additional and more precise information from the server. On the server-side, these term refinements are processed and then stored as additional data to the picture. These additional data can then be called and used by other users.

The interface (I-60) can be comprised of or made up of additional data in different representations or visualizations, between which the user can change via different tab-views or buttons. In one of these tab-views, further images for the comparison are displayed, from which the user or viewer can select one image, from which he then obtain further additional data.

Beside the previous, the same references, which are already described in FIG. 3, have an analogue meaning in FIG. 4.

A further advantage and utilization of the present invention is also obtained in the automated verification or inspection of new updates of documents or files, which by means of a content signature can request an appropriate server, whether or not new data are available to the document or to the file. The advantage of the invention is related to the feature that a request can be started by the client-sided additional function unit independently of the underlying content. The request for updates provides server-sided additional data for performing the updates, independent of the circumstances, whether the user or viewer of the content knows the contacting addresses for the updating and even if no methods are included in the content or corresponding appliances. The additional data make up or consist of address data and grant the opportunity to update the content in a further step, which preferably would occur according to the invention outside of the function unit.

Additionally, the invention provides the opportunity via categorization or classification of content in a provided text input / keyword-navigation, to make use of the already-superior or inferior categories by means of category names and sub categories of the additional data and the corresponding hyperlinks.

By means of the created data, it is then possible to find within the Internet, processed pictures or videos of landscapes or vacation areas. Special maps with hints to regions or territories can be found as well as present or current pictures of hotels and also ruins or outing destination, which, by means of structured category names as well as via the corresponding assigned server addresses, viewers or users of these pictures can be offered the opportunity to directly obtain further data. A further advantage of the present invention is obtained, in that the additional data, which are made by the creators, does not render the existing web pages useless or needless, but instead enables viewers or users to more easily surf between similar web pages and allows new users to move to these enhanced pages by means of server-sided additional data.

Additionally, additional data can be data related to the territorial assignment of pictures or output data can be attached, such that, for example, pictures or videos with the location of the picture/video recording or production information can be linked together.

In the same manner, pictures, images or videos of objects can be found by means of standardized category terms or terminology. In the same way, diagrams, formulas or computer simulations can be supplied and found with keywords.

The values attached by creators can also contain an assessment about the suitability for children. Different levels or categories of warnings can be attached via this manner to pictures, images, videos or video fragments, sectors or segments and provide tips or advice on content, which may be corrupting or harmful to youth, such that within the document-visualization/output/representation unit this type of content can be suppressed in the output or provide data such that even the entire web page can be blocked.

Particularly, the technology is suitable to find pictures of persons or corresponding pictures or images with additional content, which provide persons' names, addresses or e-Mail addresses on the server-side. As an additional service, the e-Mail addresses can be stored in a database in a manner such that its utilization can be provided in an anonymous manner, and such that the sender of a message does not recognize the actual and/or stored e-Mail addresses.

A further advantage of the present invention consists of the assignment of information in sections or to scenes of video files or streams. After the assignment of additional information to certain frames within videos, digital signatures can then be created for these frames, and these signature data can then be stored in the server-sided data-storage unit with the additional data. Moreover, scenes from movies can be attached with further metadata or additional data by viewers or users, such that the content of arbitrary movie scenes can also be found later on via text searches independent of the additional data displayed on client-sided displaying means, according to the invention, and within (a) web-browser(s).

In this way, videos such as films, documentaries, interviews, reportage, coverage, TV-shows or commercials, which are broadcast or aired, can be attached to this additional data as well. A viewer or user can then extract an image from the video or from the corresponding data stream that is displayed, for example, on a conventional user or viewer PC via a screenshot or via a means of extraction within the display or playback unit and via the function unit which is, according to the invention, sending this data to a corresponding server and is consequently receiving detailed information regarding the content of the image, and/or from the content of the scenes, and/or from the content of the entire video, from which the image is extracted, as additional data from the server. According to the invention, a further integration of the broadcast-based television in the Peer-to-Peer-based or client-server-based Internet would be possible, whereby in an advantageous manner, no further technical measures or means are required within the sender infrastructure of the television-channel.

These segment-wise valid additional data can be structured descriptions of landscapes or certain objects such as buildings or structures or acting or performing persons. These data can also be provided to search engines. Someone who is seeking content within movies would thereby have the opportunity to find directly a scene via its description, without direct provision by a publisher.

Thereby, video, movies or pictures/images can directly be found via Internet within textual description of a part of the content.

These additional data can be assigned to the picture independently from the actual publication or the original publisher and thereby the interested or involved user can be directed to the website of the publisher or to a point of sale for documents, products or the like. In this manner, with the creation of registered content signatures, further links and additional value-creating business procedures or processes can be established.

The metadata or additional data for the image and video content can contain historical background information, or its meaning, thereby providing the interested user or viewer additional information.

The same benefit arises from the subsequent attachment of information to works of art, paintings, movies, architectural buildings or structures, animals, plants, technical objects such as machines, engines, bridges or scientific pictures, images, videos, files, programs or simulations from medicine, astronomy, biology or the like. Additionally, situations in movies can be described by means of textual additional data. The same is valid for cartoons. Additionally anyone can directly search for trademark logos with the corresponding context-creating or forming additional data, which can also be extracted. As a result, a trademark owner can get information about the distribution of his logos and to the context of usage of the logos.

Furthermore, concrete objects or items such as pictures, images of consumable products or investment goods can very precisely be described with additional data as well, which can be extracted from and used via the corresponding product database.

Via the request of the digital signature at the server unit, the server gathers information about the distribution of copyright protected content. Same as for the child protection or parental control systems, the output of an accordingly characterized electronic document can been suppressed in an appropriately prepared output unit or the output of the document can be made dependent on a purchase.

The attaching of further data for the restriction of displaying additional information related to content can be done by the content or website owner via a message to the server unit. Thereby, it can be guaranteed that a web page would only be used for the marketing or commercialization for related products.

The creator of additional data related to pictures, images or content could participate in the success within the purchase of links to commercial document servers upon the successful marketing of links.

Thereby, content signatures with their server addresses and additional data can be sold or provided to search engines, such that these pictures or videos can be found within the Internet more easily. Because of the high transparency of textual search processes, each viewer or user has then, within the Internet, the opportunity to search for his name and thereby, if necessary, to determine whether an incorrect name assignment has taken place or whether a potential misuse of his image or his video has occurred.

Additionally, for all images or videos which are in the possession or within access of the user or viewer, additional data can be downloaded from the server onto the local storage unit of the computer, such that subsequent searches can be done independent of remote and of unfamiliar server-sided resources, and such that in an advantageous manner, the protection of privacy within the search can be guaranteed to a more severe degree than within an online search.

Table of references
The following table contains additional descriptions of the
references to the FIG. 1 to 5 and it is part of present
invention and its disclosure. Reference descriptions are:

| | |
|---|---|
| (10) | Network capable data processing unit or electronic data |
| | processing unit |
| (20) | Means for visual and/or acoustical output of data; data |
| | output unit |
| (25) | Electronic document |
| (30) | Means for the outputting of a document or a document |
| | outputting unit |
| (35) | Document segment |
| (38) | Means for visual representation or outputting of |
| | additional data or visual interface for additional data |
| (45) | Document files |
| (50) | Means for the calculation and determining of digital signatures |
| | or content-signature unit for creating a plurality |
| | of unique digital signature data to document segments |
| (55) | Means for the creation, outputting and management of |
| | additional data; additional data creation unit |
| (60) | Means for the data access in the electronic document or |
| | function unit for the data access or a software |
| | application with a function unit adapted to access data |
| | within the electronic document |
| (100) | Data transmission network, electronic network; means for |
| | the transmitting or transfer of data |
| (130) | Means for identification and authentication of users; |
| | identifications- and authentication unit |
| (150) | Server appliance or server unit |
| (160) | Means for the storage, reception/receiving, and transferring/ |
| | transmission of a plurality of supplementary and/or |
| | additional data or links, which are in relation to a |
| | digital signature data; catalog server relationship unit |
| (165) | Means for the management of relationships between category |
| | names and a plurality of document server addresses and/or |
| | a plurality of data request forms |
| (175) | Means for the storage, management or output of catalog |
| | data or catalog data unit or means for the storage of |
| | category names |
| (175′) | Means for the storage, management or output of category |
| | names from a local, on the client-side available database |
| | or storage unit such as a local catalog data unit |
| (200) | Means for the storage and providing or supplying of |
| | relationships between digital signature data and server- |
| | sided corresponding additional data (signature-data-to- |
| | additional-data relationship unit) |
| (210) | Means for the server-sided storage and transfer of |
| | structured data via a server-sided database |
| (250) | Means for the storage, management and transfer of server- |
| | sided stored document; document server unit |
| (300) | Means for the management and transfer of server-sided |
| | stored document or server-sided document-server unit |
| (350) | Means for the server-sided storage of the client-sided |
| | utilization of activated hyperlinks or server-sided hyperlink |
| | utilization server or utilization data storage server |
| (I-1) | Web browser interface for the displaying and output of an |
| | electronic document (25) |
| (I-2) | Navigations bar of and within the web browser |
| (I-5) | Additional toolbar within the web browser |
| (I-7) | Additional data-creation unit; means for the input and |
| | management of additional data |
| (I-10) | Means of the output of additional data |
| (I-20) | Means for the input, output and management of additional |
| | data, which are preferably organized via hierarchically |
| | top- and sub-level category name schemata |
| (I-30) | Means for the input, output and management of additional |
| | data, which comprise in the context of the interface-area |
| | (I-20) an adapted output data and input data form |
| (I-40) | Non-selected image (45) |
| (I-45) | Selected image (45) |
| (I-60) | Means for the output of additional data in an independent |
| | interface |

1. Apparatus for a client-sided creating, receiving, delivering, transmitting, representing, outputting and displaying of server-sided stored data in a via an electronic network (100) connected client-server system, with
a client-sided electronic data processing equipment (10), which is connected with the electronic network (100),
a document-visualization/output/representation unit (30), which is designed as component of the electronic data processing equipment (10) for the representing, displaying, and visualization of the electronic document (25) and
a function unit(60) that is assigned to the document-visualization/output/representation unit (30), which is designed to access data of the electronic document (25) and to transmit data to a server unit (150) that is connected to the network (100),
characterized in that
said function unit (60) comprises a content signature unit (50), which is designed to build or to form a plurality of unambiguous or unique digital signature data of a content of said electronic document (25), in particular of a document segment (35) and/or of a file (45), which is contained in said electronic document (25) and
is designed for the separate transmitting of said digital signature data by means of the network (100) to the server unit (150) and
in the server unit (150) a signature-data-to-additional-data relationship unit (200) is provided,
which is designed for the supply of server-sided additional data that are assigned to said digital signature data, whereby
said function unit (60) is designed to select and receive of additional data from said server unit (150) and
said function unit (60) effects a client-sided representing, outputting or visualization of the additional data, particularly by means of the document-visualization/output/representation unit.

2. Apparatus as set forth in claim 1, characterized in that said server-sided additional data comprise a plurality of user activatable selections or choices.

3. Apparatus as set forth in claim 2, characterized in that said user activatable selections or choices comprise of a plurality of textual data and/or image data and hyperlinks.

4. Apparatus as set forth in claim 3, characterized in that a activation is initiated out of said plurality of user activatable selections or choices or out of said plurality of hyperlinks by the user and the activation is transferred as a plurality of data to the server unit (150).

5. Apparatus as set forth in claim 4, characterized in that said plurality of data from the activation of said plurality of user activatable selection or choices or out of said plurality of hyperlinks initiated by the user are stored by the server unit (150) in the signature-data-to-additional-data relationship unit (200).

6. Apparatus as set forth in claim 5, characterized in that said server-sided additional data consist of data or are calculated on the server-side, wherby previous activation of selections or choices or hyperlinks by users are stored in the signature-data-to-additional-data relationship unit (200).

7. Apparatus as set forth in claim 6, characterized in that a predetermined selection from a plurality of context data, which are in association as data in correlation or context with the electronic document and which are extracted by the function unit (60) from the data within the electronic document (25) or an address for the calling of the electronic document or of the file (45) that is contained in the content of the electronic document, are displayed, outputted or visualized as additional data or transmitted or delivered as data to the server unit (150).

8. Apparatus as set forth in claim 7, characterized in that said context data are assigned to a plurality of predetermined category names, topic or subject names in the signature-data-to-additional-data relationship unit (200), which are linked on server-side via a relationship unit (160) to a plurality of category related or oriented predetermined data, or links to said document server and/or dynamically client-sided executable scripts.

9. Apparatus as set forth in claim 8, characterized in that said category names are linked or connected hierarchically and/or in a network-type manner and/or said category names represented by terms, which are associated in textual or meaning related or relational correlation or in context with the context data.

10. Apparatus as set forth in claim 9, characterized in that further data are contained in the hyperlink, via which a producer or a creator of the relationship between digital signature data and the category name, which is in connection or in relationship with the corresponding hyperlink, can be identified.

11. Apparatus as set forth in claim 10, characterized in that said utilization of a hyperlink that is contained in additional data is registered or recorded on the server-side in a hyperlink utilization-registration-unit (350), in which said utilization of the hyperlink by the user, which is sent to the user by said server unit (150), is stored.

12. Apparatus as set forth in claim 11 characterized in that said server-sided additional data that are corresponding or relating to document segments (35) or corresponding or relating to files (45), which are contained in said electronic document (25), are displayed by said document-visualization/output/representation unit (30).

13. Apparatus as set forth in claim 12, characterized in that said additional data are textual, visual, animated or acoustic, audio or sound data or description or descriptive data, or predetermined utilization operation, which can be activated by a user of the electronic data processing equipment (10).

14. Apparatus as set forth in claim 13, characterized in that said utilization operation are predetermined dynamic script operations or hyperlink data, which refer or link to said predetermined document server unit (300) that are connected or linked via the network (100), or fetching or receiving, displaying, or storing data from a database (210) that is connected or linked via the network (100), and/or processing said data on the data processing equipment (10).

15. Apparatus as set forth in claim 14, characterized in that said digital signature data are assigned to a plurality of predetermined category names, topic or subject names in the signature-data-to-additional-data relationship unit (200), which are referred or linked on the server-side via a relationship unit (160) to a plurality of category oriented or related predetermined data, or links to document server and/or client-sided dynamically executable scripts.

16. Apparatus as set forth in claim 15, characterized in that said category names are linked or connected hierarchically and/or in a network-type manner and/or said category names represented by terms, which are associated in textual or meaning related or relational correlation or in context with the content, for which said digital signature data has been created.

17. Apparatus as set forth in claim 16, characterized in that further data are contained in the hyperlink, via which a producer or a creator of the relationship between digital signature data and the category name, which is in connection or in relationship with the corresponding hyperlink, can be identified.

18. Apparatus as set forth in claim 17, characterized in that said utilization of a hyperlink that is contained in additional data is registered or recorded on the server-side in a hyperlink utilization-registration-unit (350), in which said utilization of the hyperlink by the user which is sent to the user by said server unit (150), is stored.

19. Apparatus as set forth in claim 18, characterized in that said additional data related to the corresponding digital signature data are used in the visualization/output/representation unit to suppress or not to output the corresponding content, particularly the document segment (35) and/or the file content (45), which is embedded in the electronic document (25).

20. Apparatus as set forth in claim 19, characterized in that to each document segment (35) or file (45) of an electronic document (25) that is displayed in the client-sided visualization/output/representation unit (30), for which corresponding server-sided additional data are contained or are available in the signature-data-to-additional-data relationship unit (200), an additional visual tag is attached to the content or is visible within the content.

21. Apparatus for a client-sided creating, receiving, delivering, transmitting, representing, outputting and displaying of server-sided stored data in a via an electronic network (100) connected client-server systems, with
a client-sided electronic data processing equipment (10), which is connected with the electronic network (100),
a document-visualization/output/representation unit (30), which is designed as component of the electronic data processing equipment (10) for the representing, displaying and visualization of the electronic document (25) and
a function unit(60) that is assigned to the document-visualization/output/representation unit (30), which is designed to access data of the electronic document (25) and to transmit data to a server unit (150) that is connected to the network (100),
characterized in that
said function unit (60) comprises a content signature unit (50), which is designed to build or to form a plurality of unambiguous or unique digital signature data of a content of said electronic document (25), in particular of a document segment (35) and/or of a file (45), which is contained in said electronic document (25) and
comprises a creation unit for additional data (55) for the inputting by a user and/or for recording, registering or inserting of additional data to said document segments (35) or to said files (45) within or inside the displayed electronic document and
is designed for the separate transmission, transmitting or delivering of said digital signature data and corresponding additional data by means of the network (100) to the server unit (150) and
in the server unit (150) a signature-data-to-additional-data relationship unit (200) is provided,
in which said additional data are stored with the corresponding digital signature data in the signature-data-to-additional-data relationship unit (200).

22. Apparatus as set forth in claim 21, characterized in that said additional data comprise a plurality of category names, topic or subject names, and/or the category names comprise attribute values, or characteristic values, and/or the textual or meaning related content is described by means of content description and/or metadata.

23. Apparatus as set forth in claim 22, characterized in that said category name are taken as value from a catalog unit (175), in which category names are stored.

24. Apparatus as set forth in claim 23, characterized in that said category name displays invariant terms, which comprise equivalent translations to other languages.

25. Apparatus as set forth in claim 24, characterized in that said category name are extended by a creator with subcategory names and/or with term relationships between category names.

26. Apparatus as set forth in claim 25, characterized in that said assignment of category names to additional data occurs in the server-sided relationship-creation-unit-for-additional-data.

27. Apparatus as set forth in claim 26, characterized in that said additional data and said corresponding digital signature data are stored after an authentication of a registered creator (130) by said server unit (200).

28. Apparatus as set forth in claim 27 characterized in that said category names are assigned by means of a relationship to names, address and parameter of a document server (160), which is accessible via the network.

29. Apparatus as set forth in claim 28 characterized in that said additional data are
person's name(s), personal description(s), characterization(s) of person(s) or the like
product name(s), product description(s), product tag(s), product parameter(s), commercial symbol(s), trademark(s) or the like
toponym(s), place name(s), landscape(s) or territory name(s), street name(s) or the like
work(s) of art name(s), work(s) of art description(s) or the like
animal name(s), animal specie(s), class or classes of animal(s), animal description(s), characterization(s) of animal(s) or the like
plant name(s), plant description(s), species of plant, characterization(s) of plant(s) or the like
event name(s), event description(s), or the like
food name(s), recipe(s), recipe name(s) or the like
description(s) of situation(s), object description(s) for technical object(s), production or manufacturing facilities, machine(s), engine(s), robot(s), technical description(s) or the like
chemical, mathematical or physical formulas, astronomical picture(s), images from scientific activities or the like
content name(s), content type data, metadata, color description(s), back- and foreground description(s), content description(s) or the like.

30. Apparatus as set forth in claims 29 characterized in that said function unit (60) is a toolbar in an Internet capable document-visualization/output/representation unit (30), particularly a web browser or media player, and the operation for the data selection, data extraction, data management, data representation, presentation, outputting, visualization and data assignment are executed or occur in a program execution platform of the document-visualization/output/representation unit (30).

31. Apparatus as set forth in claim 30 characterized in that a language for the programming of the operations in the program execution platform is JavaScript, Java™, Visual Basic or the like.

32. Apparatus as set forth in claim 31 characterized in that said additional data and content addresses with category names and/or attributes and/or metadata are used in a text oriented search engine.
